(19) United States
(12) Patent Application Publication
(10) Pub. No.: US 2018/0116254 A1
(43) Pub. Date: May 3, 2018

(54) PASTEURIZATION PLANT HAVING AN ION EXCHANGE DEVICE AND METHOD OF OPERATING A PASTEURIZATION PLANT

(71) Applicant: Red Bull GmbH, Fuschl am See (AT)

(72) Inventors: Gunnar DEMOULIN, Salzburg (AT); Roland CONCIN, Fuschl am See (AT); Christian RINDERER, Fuschl am See (AT)

(73) Assignee: Red Bull GmbH, Fuschl am See (AT)

(21) Appl. No.: 15/793,362

(22) Filed: Oct. 25, 2017

(30) Foreign Application Priority Data
Oct. 27, 2016 (AT) A50988/2016

(51) Int. Cl. A23L 3/02; B01J 39/05; B01J 39/18; B01J 41/05; B01J 41/12; A23L 3/3454

(52) U.S. Cl. CPC A23L 3/02; B01J 39/05; B01J 39/18; A23V 2002/00; B01J 41/12; A23L 3/3454; B01J 41/05

(57) ABSTRACT

The invention relates to a pasteurization plant and a method of operating a pasteurization plant. During operation of the pasteurization plant, a tempered process liquid is applied to containers filled with food products in one or more treatment zone(s). At least a part of the process liquid is fed back to the treatment zone(s) for reuse in at least one recirculation loop. At least a partial quantity of a volumetric flow of the process liquid fed per unit of time via the at least one recirculation loop is diverted to create at least one partial flow, circulated through at least one cleaning device and then returned to a recirculation loop or a treatment zone again. The at least one cleaning device comprises a membrane filtration device and an ion exchange device.

The invention relates to a pasteurization plant for food products packed in closed containers and a method of operating a pasteurization plant.

Pasteurization plants are used to preserve food products by tempering the food products in a specific way. In order to remove living microorganisms, the food products are usually heated to a higher temperature and maintained at this higher temperature for a specific time. In many cases, the food products are packed in containers and the containers closed prior to the pasteurization process and a tempered or heated process liquid is applied to the external surface of the containers in order to heat and pasteurize the food products. In this manner, a product that is already suitable for storage and sale can be produced.

So-called tunnel pasteurizers are often used for this purpose, in which case containers which have already been filled with food products and then closed are fed through one or more treatment zones and are sprayed or drenched with a tempered process liquid in a respective treatment zone. An aqueous process liquid is usually used, which is recirculated around the treatment zone(s) in a circuit so that it can be at least partially reused. On the one hand, this reduces the quantity of fresh process liquid or fresh water which might need to be added to the system. On the other hand, the amount of energy needed to temper the process liquid can also be reduced.

When recirculating the process liquid in this manner, especially in the case of a constant or continuous recirculation system, it is inevitable that contaminants will get into the aqueous process liquid during operation of the plant over time. Sources of such contaminants might be the ambient air, cooling towers used for cooling the process liquid if necessary and operating personnel for example, or the containers or their contents. For example, during the course of producing the containers, contaminants may be left on the external surface of the containers, for example due to processing steps involving the removal of material, etc. Situations may also arise in which constituents of the food products get into the process liquid during operation of a pasteurization plant due to slight leakages of containers. Leakages often occur in the region of the closures of the containers, for example in the case of screw caps on drink bottles or tabs on beverage cans.

Systems for removing contaminants from a process liquid circulating in a circuit of a pasteurization plant have already been proposed in the past. The proposed systems predominantly involve cleaning, primarily focusing on the removal of particulate substances by filtering and/or deposition. Such systems mainly involve a filtration of coarse substances or separating them using gravitational sedimentation, such as disclosed in EP 2 722 089 A1 for example.

Systems whereby fine to very fine particulate substances, including microorganisms, can be removed from a process liquid circulating in a circuit have also already been proposed. In this respect, good results can be achieved with the system proposed in WO 2016/100996 A1, which WO 2016/100996 A1 is owned by this applicant. Due to the features disclosed in WO 2016/100996 A1, a clear and at least predominantly germ-free process liquid can be obtained.

When continuously or constantly recirculating an aqueous process liquid in pasteurization plants, however, entrained substances may also be present in dissolved ionic form and/or contaminants may be entrained in the process liquid in the form of ions over time. This will depend on a respective chemical composition and other parameters of the process liquid. For example, the increased temperature or a respective pH value of the process liquid may promote dissolution of substances or contaminants or the presence of dissolved ions.

Many ions in a process liquid of a pasteurization plant are basically undesired. An example of this is dissolved aluminum ions or ions of aluminum compounds which, medically speaking, are detrimental to health. The same also applies to other metal cations, for example heavy metal cations, but also other ionically present substances. Such ions can build up in the process liquid over time if a process liquid is constantly reused in a circuit. Aluminum ions or compounds frequently occur for example, because containers containing aluminum are often processed in pasteurization plants, such as containers with aluminum caps or beverage cans made from aluminum.

In addition to being harmful to health, ionic substances dissolved in a process liquid during a treatment of containers with a view to pasteurizing food products can also lead to complications in the pasteurization process itself. Dissolved ions can only be removed using membrane filtration methods alone under certain conditions or barely at all. To date, it has been standard practice to use chemicals to regulate and stabilize the chemical composition of a process liquid and/or to remove undesired dissolved substances from a process liquid, such as corrosion inhibitors, water softeners or pH regulators, and naturally disinfectants and/or antimicrobial substances. However, this in turn usually means that these chemicals are introduced into the process liquid in undesirably high quantities, and these regulating chemicals can in turn also lead to undesired interactions, for example with the treated containers themselves. Furthermore, continuous use of large quantities of chemicals is very cost intensive and involves steps being taken to detect when it is necessary to use such regulator chemicals.

Accordingly, there is a need for further improvement in pasteurization plants in terms of continuously cleaning a process liquid which is recirculated or constantly reused in the circuit.

The objective of this invention was to propose a method of operating a pasteurization plant as well as a pasteurization plant by means of which a process liquid that is as free as possible of contaminants and/or undesired substances can be provided during operation of the pasteurization plant.

This objective is achieved by a method and a pasteurization plant as defined in the claims.

The method of operating a pasteurization plant comprises conveying containers filled with food products and closed through one or more treatment zone(s) and treating the containers with a tempered aqueous process liquid in the treatment zone(s) by applying the process liquid to an external surface of the containers. As this happens, at least a part of the process liquid, preferably a predominant part of the process liquid or the entire process liquid, from the treatment zone(s) is fed back into a treatment zone and/or into one of the treatment zones again for reuse in at least one recirculation loop. In this respect, it may be, for example, that a volumetric flow of the process liquid is fed from a treatment zone via a recirculation loop to another treatment zone.

As part of the method, at least a partial quantity of a volumetric flow of the process liquid fed respectively per unit of time via the at least one recirculation loop is continuously diverted in order to create at least a partial flow of process liquid. Accordingly, at least a partial flow is branched off from the at least one total volumetric flow of the process liquid circulating via a recirculation loop and/or one of the recirculation loops.

This at least one diverted partial flow is filtered by means of a membrane filtration device. Dissolved ions are then exchanged and removed from the at least one partial flow by means of an ion exchange device having at least one strongly acidic cation exchanger. The at least one partial flow is then fed back into a recirculation loop or a treatment zone again. The at least one diverted partial flow is preferably returned to the process liquid of the recirculation loop from which it was diverted. One of the reasons for this is that a temperature level of the at least one partial flow at least substantially corresponds to the temperature level of the process liquid circulating in the recirculation loop and can therefore be readily used for any additional tempering of the flow of process liquid fed to a treatment zone.

Accordingly, a partial flow may be diverted from a recirculation loop or from one of the recirculation loops. However, it may be that a partial quantity of the volumetric flows of process liquid circulated via several recirculation loops per unit of time may be diverted respectively from the several recirculation loops in order to create several partial flows respectively. In this context, a respective recirculation loop may be connected to the treatment zone in such a way that a volumetric flow of process liquid is fed from one treatment zone via a recirculation loop to another treatment zone, for example.

The specified method enables undesired substances to be continuously and/or constantly removed from the process liquid during ongoing operation of the pasteurization plant. On the one hand, this enables the process liquid to be kept as clear and germ-free as possible for the ongoing operation of a pasteurization plant. In addition, the concentration of undesired ions can be kept as low as possible and/or a continual rise in the concentration of undesired ions such as metal cations, for example aluminum ions or aluminum compounds present in ionic form, can be counteracted due to a continuous recirculation and reuse of the process liquid. In particular, metal cations can be efficiently removed from the partial flow or partial flows by means of the at least one strongly acidic cation exchanger of the ion exchange device. The advantage obtained as a consequence is that the use of chemicals to regulate and stabilize the process liquid being continuously recirculated and reused in the circuit can be at least significantly reduced. Due to the fact that a partial flow is being continuously diverted and cleaned, it may not be necessary to provide other means for cleaning the process liquid such as sedimentation devices or filter systems for separating large particles.

Furthermore, advantageous synergetic effects can be obtained by the combined cleaning of the diverted partial flow by means of the membrane filtration device and ion exchange device. For example, dissolved nutrients for microorganisms can be removed from the process liquid by means of the ion exchange device, thereby at least limiting the growth of microorganisms. This can in turn have positive effects on the membrane filtration process. For example, the formation of biofilms on the filter membranes of the membrane filtration device and so-called biofouling of the filter membranes can be at least significantly delayed. This in turn enables the requisite membrane filtration process capacity to be reduced and the time intervals between any cleaning and/or back-flushing operations which might be necessary for the filter membranes can be made longer.

Conversely, however, the partial flow of process liquid fed to the ion exchange device can also have opacifiers and/or coagulated particulate substances at least largely removed from it by connecting the membrane filtration device upstream. This enables an extremely friction-free and efficient removal operation to be run by means of the ion exchange device. In this connection, it is of particular advantage to filter fine and very fine particles out of the partial flow of process liquid because it enables potential blockages of the ion exchanger(s) of the ion exchange device which can be caused by these fine particulate substances to be prevented, thereby ensuring an efficient flow of the process liquid through the ion exchange device. All in all, it has been found that filtration by means of the membrane filtration device and the removal of ions by means of the ion exchange device results in outstandingly efficient cleaning of the process liquid and/or a diverted partial flow.

By using at least one strongly acidic cation exchanger, metal cations can also be removed from the partial flow of process liquid in particular without being replaced by other metal cations. Instead, removed cations and/or metal cations can be replaced by H⁺ ions which, in accordance with general understanding, are present in the aqueous process liquid due to solvation by water molecules and commonly referred to as oxonium or hydronium ions. A strongly acidic cation exchanger may comprise an ion exchanger matrix and/or an ion exchanger resin having (protonated) sulfonic acid groups as active exchanger groups, for example.

Overall, the specified features enable both undesired coagulated and/or particulate substances, including microorganisms, and undesired dissolved ions to be continuously removed from the process liquid. In particular, by removing ions by means of the ion exchange device, this also means that undesired interactions between the process liquid or ions dissolved in it and the treated containers can be prevented. For example, it has been found that due to the specified features, the occurrence of so-called wet storage stain can be effectively prevented when treating containers incorporating an aluminum material. Similarly, by filtering and removing dissolved ionic substances, deposits can be prevented from forming on the external surface of the treated containers, for example.

The advantage of cleaning a partial flow or several partial flows of process liquid in pasteurization plants in this manner is that the individual volumetric elements of the process liquid are constantly mixed due to the flow or forced flow of process liquid via the recirculation loop or recirculation loops. Such mixing is particularly effective in pasteurization plants where volumetric flows of process liquid are fed out of treatment zones and circulated respectively via recirculation loops back to other treatment zones again, for example. In other words, in such situations, individual volumetric elements of the process liquid are directed via changing recirculation loops and/or in and out of changing treatment zones during ongoing operation over time so that the entire process liquid is ultimately fed via a cleaning device over time.

As a rule, as has been found in practice, it is therefore not necessary to divert and clean a partial flow from a respective volumetric flow of every recirculation loop and instead, it is sufficient to divert and clean partial flows from a partial quantity of the recirculation loops in order to achieve efficient cleaning of the entire quantity of process liquid in a pasteurization plant. In many cases, diverting and cleaning an individual partial flow from a recirculation loop may be totally satisfactory for this purpose.

Based on a preferred embodiment of the method, a pH value of the at least one partial flow may be influenced by means of the at least one strongly acidic cation exchanger with a view to obtaining a desired pH level.

This may be achieved depending on a respective usable ion exchange capacity of the strongly acidic cation exchanger(s). For example, in order to influence the pH value of the partial flow, a flow quantity may be regulated and/or adjusted by the at least one strongly acidic cation exchanger. This aspect will be explained in more detail below. By means of the at least one strongly acidic cation exchanger, cations, mostly metal cations, are drawn out of and removed from the partial flow as it circulates continuously, and instead solvated H⁺ ions are given off into the partial flow. This being the case, multiple charged cations such as solvated Al³⁺ ions are replaced by a number of H⁺ ions corresponding to the charge of the cations. Overall, by circulating a specific quantity of process liquid through the at least one strongly acidic cation exchanger per unit of time, a desired reduction in the pH value of the partial flow and hence the entire process liquid can be obtained. The pH value of the process liquid can advantageously be at least significantly reduced by using chemicals which regulate pH value, such as acids or bases, for regulation purposes. During the course of testing, it was found that it may be of advantage to opt for a slightly acidic level of the aqueous process liquid of pasteurization plants, for example a pH value of between 4 and 7. This can prevent the occurrence of so-called wet storage stain on aluminum materials on the treated containers. Generally speaking, the pH value of the process liquid may play a large role in terms of interaction with the external surface of the containers respectively being treated. Influencing the pH value by means of the ion exchange device with a view to obtaining a desired level for the process liquid can therefore represent a major advantage for the method.

In this connection, it may also be of advantage if the at least one strongly acidic cation exchanger is regenerated depending on a change in pH value of the at least one partial flow or process liquid.

For example, if it is established by means of pH value measurements taken of the partial flow that the pH value can no longer be significantly reduced by circulating the process liquid through the at least one cation exchanger, the at least one strongly acidic cation exchanger can be regenerated. In order to adjust and stabilize the pH value at a desired level, pH regulating agents such as acids, for example, can be added to the process liquid on a replacement basis if necessary during a process of regenerating the at least one cation exchanger. If the ion exchange device comprises several strongly acidic cation exchangers or if several ion exchange devices are provided, it may not be necessary to add pH regulating agents in replacement. In this case, sufficient ion exchange capacity can be imparted to a cation exchanger again on the basis of regeneration.

Based on another embodiment, however, anions may also be drawn off or exchanged in the at least one partial flow by means of at least one strongly basic anion exchanger.

This also enables undesired anions to be drawn off or removed from the at least one partial flow of process liquid.

Again as a result of this, a pH value of the at least one partial flow can be influenced by means of the at least one strongly basic anion exchanger with a view to obtaining a desired pH level.

For example, it may be again that a flow quantity circulated through the at least one strongly basic anion exchanger is adjusted or regulated in order to influence the pH value of the partial flow. In principle, a respective number and exchange capacity of strongly acidic cation exchangers and strongly basic anion exchangers can be selected and adapted with a view to obtaining a respectively desired pH level of the process liquid, as will be explained in more detail below. As has been established, it may be of advantage in the case of an aqueous process liquid for pasteurization plants to opt for a pH value of less than 8, in particular between 4 and 7, for example in order to counteract the occurrence of so-called wet storage stain on aluminum materials on the treated containers. On the other hand, the pH value can be prevented from falling too far by influencing the pH level of the process liquid by means of the at least one cation exchanger and/or the at least one anion exchanger of the ion exchange device, for example. This means that an aluminum material of the containers can be prevented from being dissolved by the process liquid, for example.

Also in this connection, one advantageous embodiment is one in which the at least one strongly basic anion exchanger is regenerated depending on a change in pH value of the at least one partial flow.

For example, if it is established by means of pH value measurements taken on the at least one partial flow that the pH value of the partial flow can no longer be reduced significantly or too sharply by circulating it through the ion exchange device, the at least one strongly basic anion exchanger can be regenerated, for example. This may be a sign that the anion exchanger no longer has sufficient ion exchange capacity. Regeneration enables a strongly basic anion exchanger to be restored to a sufficient, usable ion exchange capacity again.

Based on another embodiment, a content of ions dissolved in the partial flow can be monitored by sensors upstream and downstream of the ion exchange device respectively.

On the one hand, this enables the ion exchange process to be monitored. However, monitoring the content of ions dissolved in the partial flow by means of sensors also enables monitoring to be conducted on the basis of the purity or quality of the aqueous process liquid in principle. A sensor system for monitoring the content of ions may comprise conductivity sensors fluidically connected upstream and downstream of the ion exchange device respectively, for example.

However, it may also be of practical advantage if a content or concentration of ions dissolved in the at least one partial flow is monitored by measuring a pH value of the at least one partial flow respectively upstream and downstream of the point where ions are removed by means of the ion exchange device.

This approach can also be used to establish the content of ions dissolved in the process liquid because a change in the pH value of the partial flow after circulating through the ion exchange device is directly correlated with the quantity of dissolved ions in the process liquid. This is the case in particular if the usable ion exchange capacity of all the available strongly acidic cation exchangers and strongly basic anion exchangers of the ion exchange device or one of the ion exchange devices at any one time is at least approximately known. The particular advantage of this is that it offers the possibility of using a relatively simple pH value measurement to glean information about ion content and the quality of the aqueous process liquid. This feature can naturally be employed to particularly good effect if a respectively usable ion exchange capacity of all the available strongly acidic cation exchangers is not the same as a respectively usable ion exchange capacity of all the available strongly basic anion exchangers or if the ion exchange device has no strongly basic anion exchanger at all, for example. What this means in principle is that the pH value can be influenced and/or adjusted by means of the ion exchange device to a greater degree, the more ions there are dissolved in the process liquid. Generally speaking, based on one advantageous embodiment of the method, the at least one partial quantity of process liquid diverted in order to create the at least one partial flow is regulated by means of a flow regulating device.

As a result of this feature, the quantity of process liquid diverted from a recirculation loop in order to create the at least one partial flow can be specifically influenced and fixed. This being the case, the at least one partial quantity of process liquid that is respectively diverted can be adapted to the respective degree of contamination of the process liquid accordingly. This applies to both filterable particulate and/or coagulated substances and undesired ions dissolved in the process liquid. This also offers a control option whereby a pH value of the partial flow and hence also the process liquid can be influenced with a view to obtaining a respectively desired level. This can be achieved on the basis of a ratio of a respective usable ion exchange capacity of the available strongly acidic cation exchangers and strongly basic anion exchangers. For example, if a partial flow diverted from a recirculation loop is fed through an ion exchange device with a higher strongly acid cation exchange capacity than strongly basic anion exchange capacity, a pH-level of the partial flow and/or process liquid can be further reduced by increasing the partial quantity diverted in order to create the partial flow, in other words by increasing the volumetric flow of the partial flow.

However, it may also be of advantage if a part of the process liquid drawn off from the at least one diverted partial flow by means of at least one flow regulating means is fed through the ion exchange device and then returned to the at least one partial flow again.

In particular, this offers another control option whereby the quantity of dissolved ions removed from a partial flow can be influenced. Furthermore, this feature also offers a way of specifically influencing a pH value of the partial flow with a view to obtaining a desired pH level for the partial flow and/or the process liquid.

In this respect, it may also be of practical advantage if the flow quantity of the process liquid is regulated respectively by means of a flow regulating means separately for each ion exchanger of the ion exchange device.

The options for controlling the ion exchange device can be further improved as a result of this feature. In particular as a result of this feature, the pH value of the partial flow can be influenced more precisely with a view to obtaining a desired level because the discharge of solvated H⁺ ions and/or hydroxyl ions can be regulated and controlled in a specific manner.

Based on another embodiment of the method, before removing the dissolved ions, the at least one partial flow may additionally be directed through a liquid treatment device comprising metal particles or a metal mesh comprising copper and/or zinc.

Spontaneous oxidation and/or reduction reactions of specific substances dissolved in the process liquid can be triggered by means of such a liquid treatment device. This will depend on the respective standard electrode potentials of the dissolved substances compared with the standard electrode potentials of copper or zinc at respectively specified parameters, such as the pH value of the process liquid. In this manner, more noble metal cations than copper and/or zinc can be removed from the partial flow by means of the relatively simple and inexpensive liquid treatment device for example, such as heavy metal ions, iron ions, etc.. This is in turn of advantage with regard to the efficiency of the downstream ion exchange device because the ions separated and removed by means of the liquid treatment device no longer have to be removed from the partial flow by means of the ion exchange device and are not competing with other ions dissolved in the partial flow when to comes to the ion exchange. The usable ion exchange capacity of the ion exchangers of the ion exchange device is therefore advantageously available for separating and removing other undesired dissolved ions which cannot be removed by means of the liquid treatment device, such as aluminum ions and ions of aluminum compounds. This further improves the efficiency with which the partial flow can be cleaned. Furthermore, due to the spontaneous redox reactions in the liquid treatment device, substances which are capable of inhibiting the growth of micro-organisms are formed in the partial flow.

However, it may also be of practical advantage if after removing dissolved ions, dissolved substances are also removed from the at least one partial flow by means of an adsorption device.

For example, it may be of advantage if the dissolved substances are removed from the at least one partial flow by means of an activated carbon filter.

As a result of these features, in addition to the undesired dissolved ions, other undesired and in particular uncharged and/or non-ionic substances which may be present can be removed from the at least one partial flow.

In principle, it may be expedient to operate a method whereby the food products in the containers are heated in a treatment zone or are heated in several treatment zones successively and then pasteurized in a treatment zone or in several treatment zones, after which they are cooled in a treatment zone or cooled in several treatment zones successively.

This makes for a particularly gentle pasteurization process for the food products because large jumps in the temperature of the tempered process liquid can be avoided. Furthermore, tempering of the food products in a respective container is more even.

Also of advantage is another embodiment of the method whereby a partial volumetric flow of the process liquid is directed through a heat exchanger of an air-cooled cooling tower, depending on requirements.

The efficiency of the process for cleaning the process liquid can also be increased as a result of this feature. This is primarily the case because contaminants can be prevented from getting into the process liquid due to and/or in the air-cooled cooling tower. Such air-cooled cooling towers are often needed for cooling a part of the process liquid, which cooled process liquid can in turn be used for cooling containers once the pasteurization process has been completed, for example. Due to the usually high cooling capacity required of cooling towers, the amount of entrained contaminants in the case of conventional cooling towers without heat exchangers can be very high indeed.

Finally, containers incorporating a metal material, in particular containers incorporating an aluminum material, can be treated by means of the pasteurization plant, at least temporarily or intermittently.

As a result, the range of containers which can be treated by means of the pasteurization plant can be further extended. In particular, containers with very thin walls which are extremely well suited to packing and storing preserved food products due to the properties of aluminum and aluminum alloys can be treated. Containers incorporating an aluminum material are challenging from various points of view when it comes to treatment for pasteurization purposes. Firstly, constituents of aluminum can undesirably get into the process liquid during the course of the pasteurization treatment and may be dissolved in the process liquid under certain circumstances. Furthermore, containers incorporating an aluminum material are particularly susceptible to superficial chemical and/or physical changes caused by the process liquid itself. This is the case with wet storage stain mentioned above, for example. Aluminum materials are often used for the closures of containers, for example. However, there are also many types of container that are mainly made from an aluminum material, such as cans used for packaging long-life food products, or for example beverage cans.

The objective of the invention is also achieved by means of a pasteurization plant for food products packaged in closed containers.

The pasteurization plant comprises one or more treatment zone(s) with delivery means(n) for applying a tempered process liquid to the external surface of the containers and a conveyor device for conveying the containers through the treatment zone(s). The pasteurization plant further comprises at least one recirculation loop for diverting the process liquid from the treatment zone(s) and for recirculating at least a part of the diverted process liquid to a treatment zone and/or to one of the treatment zones.

At least one cleaning device is provided, which at least one cleaning device is fluidically connected to a removal means for removing a partial flow of process liquid from the at least one recirculation loop, and which at least one cleaning device is connected to a returning means for returning the partial flow to a recirculation loop or a treatment zone by a pipe system. The at least one cleaning device comprises a membrane filtration device for filtering the removed partial flow. The at least one cleaning device further comprises an ion exchange device having at least one strongly acidic cation exchanger fluidically connected downstream of the membrane filtration device.

In order to circulate a removed partial flow through the membrane filtration device and ion exchange device, the at least one cleaning device comprises conveying means. It may preferably be possible to enable the at least one cleaning device to be selectively shut off from or opened to permit a flow from the recirculation loop, for example via at least one shut-off element. The membrane filtration device may comprise one or more filter modules and/or filter units for example, provided for the circulation of a removed or diverted partial flow or parts of a diverted partial flow during operation of the pasteurization plant.

Due to the specified features, a pasteurization plant for food products packed in closed containers is proposed, in which the greatest possible proportion of the aqueous process liquid can be permanently reused. Above all as a result of the specified features, means are provided for efficiently cleaning the process liquid circulated in a recirculation loop or several recirculation loops. In this context, the membrane filtration processing system(s) enable(s) coagulated and/or particulate substances to be efficiently removed from the process liquid. By means of the ion exchange device(s), undesired dissolved ions such as solvated aluminum ions or aluminum compounds present in ionic form can be drawn off or removed from the process liquid. This being the case, the synergetic effect of the membrane filtration device fluidically connected upstream of the ion exchange device effectively prevents the ion exchange device from becoming blocked by particulate substances. Furthermore, due to the specified features, other means for cleaning the process liquid during operation of the pasteurization plant, such as sedimentation devices or filter systems for separating coarse particles, can optionally be dispensed with.

The at least one cleaning device is fluidically connected via a removal means to a recirculation loop. In principle, a removal means may be a simple distributor element, for example a T-piece, which enables a partial flow to be branched off from a recirculation loop. Adjoining it, conveying elements may be provided, such as pipes, for circulating a partial flow of process liquid diverted from a recirculation loop diverted through the at least one cleaning device, in other words through the membrane filtration device and then through the ion exchange device. A diverted and cleaned partial flow can then be fed via a returning means, such as a pipe, back into a recirculation loop or a treatment zone again. Other advantageous elements, in particular control means for regulating the quantity of process liquid removed from a recirculation loop, will be explained in more detail below. In principle, it would also be possible to fluidically connect several cleaning devices respectively via one removal means respectively to a recirculation loop and/or to one of the recirculation loops of the pasteurization plant.

By using at least one strongly acidic cation exchanger, metal cations in particular can also be efficiently removed from a diverted partial flow of process liquid during operation of the pasteurization plant without being replaced by other metal cations. Instead, removed cations and/or metal cations are replaced by solvated H⁺ ions. A strongly acidic cation exchanger may comprise an ion exchanger matrix and/or an ion exchanger resin having sulfonic acid groups as active groups, for example. Furthermore, due to the at least one strongly acidic cation exchanger of the ion exchange device, a pH value of the partial flow can be influenced with a view to obtaining a desired pH level of a diverted partial flow. The advantage of this is that the use of pH-reducing chemicals such as acids or bases as a means of influencing the pH value of the process liquid can be at least significantly reduced.

Other advantages which can be achieved by the specified features of the pasteurization plant have already been explained in the description of the method of operating the plant given above. There is no need to describe these again at this point.

Furthermore, the ion exchange device may comprise at least one strongly basic anion exchanger.

As a result of this feature, undesired anions can also be separated and removed from a diverted partial flow of process liquid during operation of the pasteurization plant. In addition, a pH value of the diverted partial flow can also be influenced by means of the at least one strongly basic anion exchanger with a view to obtaining a desired pH level. A strongly basic anion exchanger may comprise an ion exchanger matrix and/or an ion exchanger resin having quaternary ammonium groups as active groups, for example.

Based on another advantageous embodiment, the ion exchange device may be fluidically connected by a pipe system to at least one regeneration means for regenerating the ion exchanger(s).

As a result, both the at least one strongly acidic cation exchanger and the at least one strongly basic anion exchanger can be regenerated depending on requirements, in order to make sufficient usable ion exchange capacity available in each case and/or to respectively influence the pH value of a diverted partial flow with a view to obtaining a desired pH level by means of the ion exchange device.

Based on another embodiment, it may be of advantage to provide a sensor means arranged fluidically upstream and downstream of the ion exchange device respectively for monitoring a content of dissolved ions in the partial flow.

In this manner, the ion exchange process can be monitored. However, monitoring the content of ions dissolved in the partial flow by a sensor system also means that the purity or quality of the aqueous process liquid can be monitored in principle. For example, conductivity sensors may be fluidically connected respectively upstream and downstream of the ion exchange device as a means of monitoring the content of ions.

Based on a preferred embodiment, a pH value sensor may be arranged fluidically upstream and downstream of the ion exchange device respectively.

By means of these pH measuring sensors, a change in the pH value of a diverted partial flow of process liquid caused by the ion exchange device can be detected during operation of the pasteurization plant. The advantage of this is that monitoring the pH value enables information to be gleaned about the purity and/or content of ions dissolved in the process liquid.

This being the case, based on another embodiment of the pasteurization plant, it may be of advantage to select a ratio of an ion exchange total capacity of all the available strongly acidic cation exchangers to an ion exchange total capacity of all the available strongly basic anion exchangers depending on requirements with a view to obtaining a desired pH value of the process liquid.

As a result, effective means for influencing the pH value of a diverted partial flow can be provided with a view to obtaining a respectively desired pH level during operation of the pasteurization plant. Influencing the pH value by means of the ion exchange device then advantageously means that at least the quantity of chemical pH regulating agents can be significantly reduced. It has been found in practice that a slightly acidic level of the process liquid, for example an average pH value of between 4 and 7, can be of benefit in terms of treating the external surface of the containers. This may be of advantage as a means of preventing the occurrence of so-called wet storage stain on aluminum materials on the treated containers, for example. Accordingly, the ion exchange total capacity of all the available strongly acidic cation exchangers may be selected so as to be higher than the ion exchange total capacity of all the available strongly basic anion exchangers.

Based on another embodiment of the pasteurization plant, a flow regulating device is assigned to the at least one cleaning device.

As a result of this design feature, operation of the pasteurization plant is assisted by a means for regulating in a specific manner the removal of a partial quantity from a volumetric flow of process liquid being circulated in a recirculation loop. As a result, the respectively diverted at least one partial quantity of process liquid can be adapted to a respective degree of contamination of the process liquid accordingly, for example. This applies to both filterable, particulate and/or coagulated substances and undesired ions dissolved in the process liquid. This also offers a control option whereby a pH value of the partial flow and hence also the process liquid can be influenced with a view to obtaining a respectively desired level. This can be achieved on the basis of a ratio of a respective usable ion exchange capacity of the available strongly acidic cation exchangers and strongly basic anion exchangers. For example, the flow regulating device may comprise a fluidic flow regulating element, for example a flow control valve which can be operated in steps or steplessly.

Based on another advantageous embodiment, however, the ion exchange device is arranged fluidically parallel with a flow line for the partial flow in the at least one cleaning device via at least one flow regulating means.

This offers another control option for operating the pasteurization plant, in particular for influencing the quantity of dissolved ions removed from a partial flow. Furthermore, a pH value of the partial flow can be influenced in a specific way by these means with a view to obtaining a desired pH level for the partial flow and/or process liquid. The flow regulating means may in turn be provided in the form of a fluidic flow regulating element which is controlled manually or on an automated basis, for example.

In this respect, every ion exchanger of the ion exchange device is assigned a flow regulating means.

As a result, the flow quantity through each ion exchanger of the ion exchange device respectively is controlled or regulated separately. In particular as a result of this feature, a means is provided which can influence the pH value of the partial flow more accurately with a view to obtaining a desired level because the discharge of solvated H⁺ ions and/or hydroxyl ions can be efficiently regulated and controlled in a specific manner during operation of the pasteurization plant.

Another advantageous embodiment of the pasteurization plant is one in which the at least one cleaning device comprises another liquid treatment device comprising metal particles or a metal mesh comprising copper and/or zinc, which liquid treatment device is fluidically connected between the membrane filtration device and the ion exchange device.

Spontaneous oxidation and/or reduction reactions of specific substances dissolved in the process liquid can be triggered by means of such a liquid treatment device during operation of the pasteurization plant. In this manner, more noble metal cations than copper and/or zinc can be removed from a diverted partial flow for example, such as heavy metal ions, iron ions, etc.. This is in turn of advantage with regard to the efficiency of the downstream ion exchange device because the ions separated and removed by means of the liquid treatment device no longer have to be removed from the partial flow by means of the ion exchange device and are not competing with other ions dissolved in the partial flow when it comes to the ion exchange. The usable ion exchange capacity of ion exchangers of the ion exchange device is therefore advantageously available for separating and removing other undesired dissolved ions which cannot be removed by means of the liquid treatment device, such as aluminum ions and ions of aluminum compounds.

The at least one cleaning device may also comprise an adsorption device, which adsorption device is fluidically connected downstream of the ion exchange device.

In addition, the adsorption device may have an activated carbon filter.

As a result, means are provided which, in addition to the undesired dissolved ions, are also able to remove other undesired and in particular uncharged and/or non-ionic substances which may be present from a partial flow of process liquid that has been diverted or taken from a recirculation loop.

Finally, to further improve the pasteurization plant, it may also comprise an air-cooled cooling tower which comprises a heat exchanger provided with conveying elements which can be selectively shut off or selectively opened to enable a flow of process liquid.

The efficiency of the process for cleaning the process liquid can also be increased as a result of this feature. This is primarily the case because contaminants can be prevented from getting into the process liquid due to and/or in the air-cooled cooling tower. Such air-cooled cooling towers are often needed in pasteurization plants for cooling a part of the process liquid, which cooled process liquid can in turn be used for cooling containers once the pasteurization process has been completed, for example. Due to the usually high cooling capacity required of such cooling towers, the amount of entrained contaminants in the case of conventional cooling towers without heat exchangers can be very high indeed.

To provide a clearer understanding, the invention will be described in more detail below with reference to the appended drawings.

These are highly simplified, schematic diagrams respectively illustrating the following:

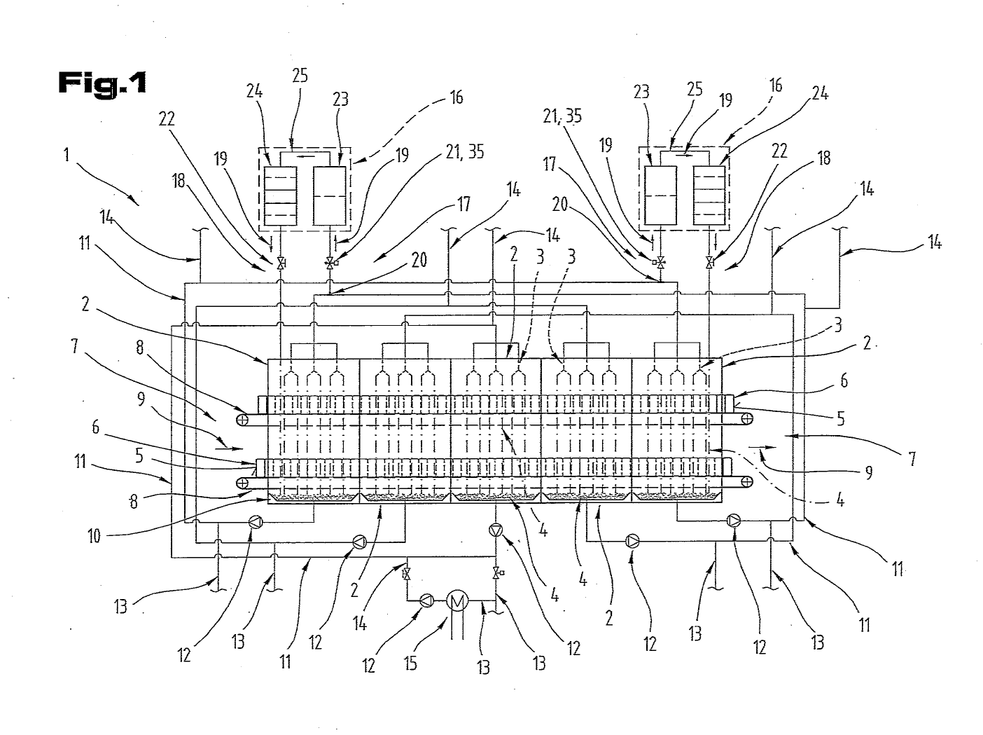

FIG. 1 a schematic diagram illustrating one example of an embodiment of a pasteurization plant;

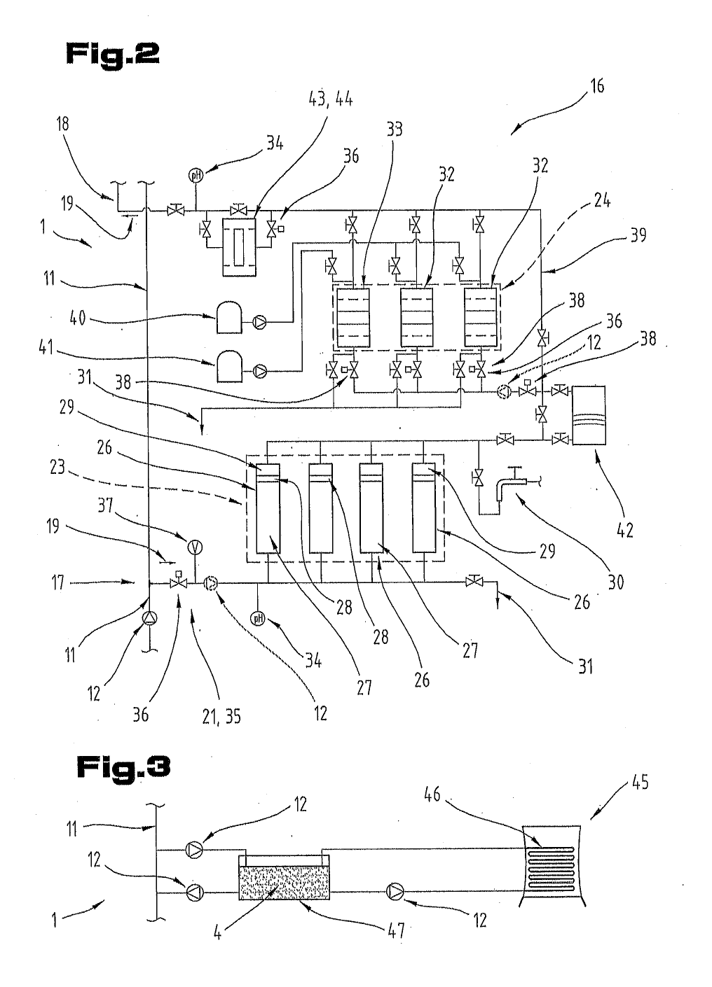

FIG. 2 a schematic diagram illustrating one example of an embodiment of a cleaning device of the pasteurization plant;

FIG. 3 a detail of a schematic diagram illustrating parts of an example of another embodiment of the pasteurization plant.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

FIG. 1 schematically illustrates an example of an embodiment of a pasteurization plant 1. The pasteurization plant 1 comprises one or more treatment zone(s) 2 with delivery means 3 for applying a process liquid 4 to an external surface 5 of containers 6. In the embodiment illustrated as an example in FIG. 1, 5 treatment zones 2 are illustrated by way of example but it goes without saying that it would also be possible to provide more or fewer treatment zone(s) 2 depending on the requirements and design of a pasteurization plant 1.

Food products are pasteurized during operation of the pasteurization plant 1 and the containers 6 are firstly filled with the food products and the containers 6 are then closed. The containers 6 filled with the food products and then closed are treated in a respective treatment zone 2 by applying an aqueous process liquid 4 to an external surface 5 of the containers 6 via the delivery means 3. The delivery means 3 of a respective treatment zone 2 may be provided in the form of sprinkler or nozzle type sprying means or generally means for distributing the process liquid in a respective treatment zone 2. The tempered aqueous process liquid 4 is applied to the external surface 5 of the containers 6 in this manner so that the containers 6 and hence the food products packaged in the containers 6 can be tempered in a specific way and pasteurized. In principle, containers 6 incorporating a metal material, in particular containers 6 incorporating an aluminum material, can be at least intermittently treated by means of the pasteurization plant 1.

In order to convey the containers 6 through the treatment zone(s) 2, a conveyor device 7 is provided. In the embodiment illustrated as an example in FIG. 1, the conveyor device 7 comprises two driven conveyor belts 8 by means of which the containers 6 which have been filled with food products and closed are conveyed through the treatment zone(s) 2 on two levels during operation of the pasteurization plant 1. This may be done from left to right, for example, in a conveying direction 9 indicated by arrows in FIG. 1.

During operation of the pasteurization plant 1, the food products in the containers 6 can be heated first of all in a treatment zone 2 or in several treatment zones 2. In the embodiment illustrated as an example in FIG. 1, the food products and containers 6 can be successively heated in the two treatment zones 2 illustrated on the left-hand side in FIG. 1, for example. After heating, the food products can be pasteurized in a treatment zone 2 or several treatment zones 2, for example by applying a process liquid 4 appropriately tempered for pasteurization purposes in the treatment zone 2 illustrated in the center in FIG. 1. The food products and containers 6 can then be cooled in a treatment zone 2 or in several treatment zones 2. The containers 6 can be successively cooled by applying a process liquid 4 at a temperature suitable for cooling purposes in the two treatment zones 2 illustrated on the right-hand side in FIG. 1.

For example, the food products are heated in treatment zone 2 disposed first of all in the conveying direction 9 and are then further heated in the next treatment zone 2 disposed in the conveying direction 9. In the next treatment zone 2 disposed in the conveying direction 9, the food products can then be pasteurized by applying a process liquid 4 at a particularly high temperature, for example between 70° C. and 110° C., to the external surface 5 of the containers 6. In the next two treatment zones 2 disposed in the conveying direction 9, the food products and containers 6 can then be cooled in a specific manner using an appropriately tempered cooler process liquid 4. The main advantage of this is that the food products are pasteurized as gently as possible, in particular without the tempering process itself causing damage to the food products.

After applying the tempered process liquid 4 to the external surface 5 of the containers 6 in the treatment zone(s) 2, the process liquid can be collected in a bottom floor region 10 of a respective treatment zone 2 and fed back out of a respective treatment zone 2. In order to discharge the process liquid 4 from the treatment zone(s) 2 and return at least a part of the discharged process liquid 4 to a treatment zone 2 or to one of the treatment zones 2, the pasteurization plant 1 comprises at least one recirculation loop 11. During operation of the pasteurization plant 1, therefore, at least a part of the process liquid 4, preferably a predominant part of the process liquid 4 or the entire process liquid 4, is fed out of the treatment zone(s) 2 for reuse in this at least one recirculation loop 11 and back into a treatment zone 2 again.

As may be seen from the embodiment illustrated as an example in FIG. 1, the process liquid 4 is fed out of a treatment zone 2 via a recirculation loop 11 and fed into another treatment zone 2, for example. In the embodiment illustrated as an example, the process liquid 4 is fed out of the treatment zone 2 shown on the far left-hand side via a recirculation loop 11 and into the treatment zone 2 shown on the far right-hand side, for example. Conversely, the process liquid 4 can be fed out of the treatment zone 2 shown on the far right-hand side via a recirculation loop 11 into the treatment zone 2 shown on the far left-hand side for heating the containers 6 and food products, for example. This may be of particular advantage because the process liquid 4 is cooled or heated accordingly whilst it is being applied to and is acting on the containers 6. Due to this cooling and/or heating, the process liquid 4 from one respective treatment zone 2 may therefore be at a suitable temperature for another treatment zone 2. Alternatively, it may also be of advantage if the process liquid 4 from a treatment zone 2 is fed via a recirculation loop 11 back into the same treatment zone 2, as may be seen in the case of treatment zone 2 illustrated in the middle in FIG. 1 which is used to pasteurize the food products.

In order to convey and/or direct respective volumetric flows of process liquid 4 in the recirculation loop 11 or in the recirculation loops 11, conveying means 12 may be respectively provided, for example pumps, as illustrated in FIG. 1. Furthermore, the pasteurization plant 1 is provided with means 13 for discharging parts of the process liquid 4 from the recirculation loop 11 and/or out of the recirculation loops 11, for example for sampling purposes, and means 14 for feeding in substances such as fresh process liquid 4, for example fresh water, or chemicals, etc.. Such means 13, 14 might be provided in the form of pipes, for example, which are run so as to feed process liquid 4 into and/or out of collection tanks, etc., or which means 13, 14 are fluidically connected to heating and/or cooling devices for the purpose of tempering process liquid. A heating device 15 is illustrated by way of example in FIG. 1, for example a steam heater or a heat pump, which heating device 15 is fluidically connected via means 13, 14 to the recirculation loop 11 in order to return process liquid 4 to the centrally illustrated treatment zone 2. In this manner, the process liquid for this recirculation loop 11 can be respectively heated to the temperature needed for the process of pasteurizing the food products.

Due to the continuous circulation of the process liquid 4 via the recirculation loop 11 or recirculation loops 11 and/or the continuous reuse of the process liquid 4 during operation of the pasteurization plant 1, contaminants and/or undesired substances can get into the aqueous process liquid over time. To enable these undesired substances and/or contaminants to be continuously removed from the process liquid 4, at least one cleaning device 16 is provided. The at least one cleaning device 16 is fluidically connected to a removal means 17 for removing a partial flow 19 of process liquid 4 from the at least one recirculation loop 11. The at least one cleaning device 16 is also fluidically connected to a returning means 18 for returning the removed partial flow 19 to a recirculation loop 11 or a treatment zone 2. As a result, during operation of the pasteurization plant 1, at least a partial quantity of a volumetric flow of process liquid 4 circulated via the at least one recirculation loop 11 per unit of time can be diverted to create at least one partial flow 19, as indicated by the arrows in FIG. 1.

In the embodiment illustrated as an example in FIG. 1, two cleaning devices 16 are illustrated by way of example, which cleaning devices 16 are fluidically connected to different recirculation loops 11 respectively. Naturally, it would also be possible to provide only one cleaning device 16 or a pasteurization plant 1 may also have more than two cleaning devices 16. The number and also the cleaning capacity of cleaning device(s) 16 will be selected and/or set respectively taking account of the size and treatment capacity of a respective pasteurization plant 1 amongst other things. Furthermore, it would also be perfectly possible to provide several cleaning devices 16 fluidically connected via removal means 17 to a recirculation loop 11 and/or to one of the recirculation loops 11.

In principle, a removal means 17 may be a simple distribution element, for example having a T-piece 20 which enables a partial flow 19 to be diverted from a recirculation loop 11, as schematically illustrated in FIG. 1. A returning means 18 may comprise a pipe, for example, by means of which a cleaned partial flow 19 can be returned to a treatment zone 2, as illustrated by way of example in FIG. 1. To make allowance for and/or compensate the pressure loss across the at least one cleaning device 16, the partial flow 19 may be returned to a pipe of a recirculation loop 11 via another T-piece for example, as an alternative to the embodiment illustrated as an example in FIG. 1. Other elements may also be provided, such as control means 21 and/or shut-off means 22, for example to enable a partial quantity of process liquid 4 diverted and/or removed from a volumetric flow in a recirculation loop 11 to create a partial flow 19 to be influenced and/or regulated, and/or to enable a cleaning device 16 to be shut off from a recirculation loop depending on requirements. Examples of such other elements will be explained in more detail with reference to FIG. 2.

As also illustrated in FIG. 1, the at least one cleaning device 16 comprises a membrane filtration device 23 for filtering the removed partial flow 19. The at least one cleaning device 16 further comprises an ion exchange device 24 fluidically connected downstream of the membrane filtration device 23, which ion exchange device 24 has at least one strongly acidic cation exchanger. Conveying means 25 are provided to enable the at least one diverted and/or removed partial flow 19 to be circulated through the at least one cleaning device 16.

As a result, during operation of the pasteurization plant 1, the at least one partial flow 19 removed or diverted from a recirculation loop 11 can be filtered by means of a membrane filtration device 23 and dissolved ions can then be removed from the at least one partial flow 19 by means of an ion exchange device 24 having at least one strongly acidic cation exchanger. Having been cleaned in this manner, the at least one partial flow 19 can then be returned via a returning means 18 to a recirculation loop 11 or to a treatment zone 2 again. The at least one diverted partial flow 19 is preferably returned to the process liquid 4 of the same recirculation loop 11 from which it was removed, as also illustrated in FIG. 1. This is of advantage among other things because a temperature of the at least one partial flow 19 at least substantially corresponds to a temperature level of the process liquid 4 circulating in the recirculation loop 11.

In this manner, undesired substances can be continuously and/or constantly removed from the process liquid 4 during operation of the pasteurization plant 1. This firstly enables the process liquid 4 to be kept as clear and germ-free as possible for the ongoing operation of a pasteurization plant 1. In addition, the concentration of undesired ions such as metal cations, for example aluminum ions or aluminum compounds present in ionic form, can be kept as low as possible.

In addition, a pH value of the partial flow can be influenced by means of the at least one strongly acidic cation exchanger of the ion exchange device 24 with a view to obtaining a desired pH level during operation of the pasteurization plant 1 because the cations removed from the partial flow 19 are replaced by solvated H⁺ ions.

Other advantageous embodiments of the pasteurization plant 1 and embodiments of the method will be explained in more detail with reference to FIG. 2. The same reference numbers and component names are used in FIG. 2 for parts that are the same as those described with reference to FIG. 1 above. To avoid unnecessary repetition, reference may be made to the detailed description of FIG. 1 given above.

As illustrated in FIG. 2, a partial flow 19 of process liquid diverted from a recirculation loop 11 is firstly directed through a membrane filtration device 23. The membrane filtration device 23 of the cleaning device 16 may comprise several filter modules 26 and in FIG. 2, 4 filter modules 26 are illustrated by way of example. The number of filter modules 26 and also the filtration capacity of the filter modules 26 may be adapted respectively to the anticipated degree of soiling and/or to the volume of process liquid circulated during operation of the pasteurization plant 1. In principle, the filter modules 26 of the membrane filtration device 23 may be arranged in any configuration in the membrane filtration device 23, for example fluidically connected in series one after the other. In the embodiment illustrated in FIG. 2, the filter modules 26 are fluidically connected in parallel so that a partial quantity of the partial flow 19 can be circulated across or through a filter module 26 respectively.

The individual filter modules 26 may basically be of any design as long as they enable a tempered aqueous process liquid to be filtered. For example, a filter module 26 may have a plurality of hollow fiber membranes which may be mounted in a retentate chamber 27 on the intake side. These hollow fiber membranes may have pores with a pore diameter of between 0.01 μm and 0.5 μm for example, thus being suitable for micro- and/or ultra-filtration. The respectively open ends of the hollow fiber membranes of a filter module 26 may be embedded in a sealing means 28 in such a way that the open ends and the inner cavities of the hollow fibers open into a filtrate or permeate chamber 29 of a filter module 26. Accordingly, the sealing means 28 separate the retentate chamber 27 from the permeate chamber 29 in a sealed arrangement so that the at least one partial flow 19 of aqueous process liquid can only flow from the retentate chambers 27 by passing through the hollow fiber membrane walls from an external surface of the hollow fiber membranes into the interior of the hollow fibers and into the permeate chambers 29 of the filter modules 26. The at least one partial flow 19 is thus filtered and particulate and/or coagulated contaminants are held back on the retentate side.

As also illustrated in FIG. 2, the filter modules 26 of a membrane filtration device 23 can be respectively connected on the permeate or filtrate side to a back-flush liquid source 30 and on the retentate or intake side to a discharge 31 by pipes which can be shut off or opened as and when required sein. As a result, the filter modules 26 of the membrane filtration device 23 can be cleaned with a back-flushing liquid by reversing the flow direction through the filter modules 26 in order to clean the filter membranes, for example the hollow fiber membranes. For example, a filter cake can be removed from the retentate side of the filter membranes in this manner. In this respect, all of the filter modules 26 of a membrane filtration device 23 can be cleaned together, as also illustrated in FIG. 2. Alternatively, however, it may be that groups of filter modules or even every filter module 26 separately is connected to a back-flush liquid source 30 and a discharge 31 and can be selectively shut off or opened. Clean fresh water may be used as the back-flushing liquid, for example, to which cleaning chemicals may be added if necessary. In addition, the filter membranes may be flushed with a gas on the retentate side to assist the cleaning with back-flushing and to prevent a filter cake from building up.

As illustrated in FIG. 2, an ion exchange device 24 is fluidically connected downstream of the membrane filtration device 23 in the cleaning device 16. The ion exchange device 24 has at least one strongly acidic cation exchanger 32. In the embodiment illustrated as an example in FIG. 2, the ion exchange device 24 comprises two cation exchangers 32. As described above, a pH value of the partial flow 19 can be influenced by means of the cation exchanger(s) 32 during operation of the pasteurization plant 1 with a view to obtaining a desired pH level. A strongly acidic cation exchanger 32 may comprise an ion exchanger matrix and/or an ion exchanger resin having sulfonic acid groups as active groups, for example.

As also illustrated in FIG. 2, however, the ion exchange device 24 may comprise at least one strongly basic anion exchanger 33. As a result, undesired anions can also be removed from the at least one diverted partial flow 19 by means of the at least one strongly basic anion exchanger 33 during operation of the pasteurization plant 1. A strongly basic anion exchanger may comprise an ion exchanger matrix and/or an ion exchanger resin having quaternary ammonium groups as active groups, for example. A pH value of the at least one partial flow 19 can be influenced by means of the at least one strongly basic anion exchanger with a view to obtaining a desired pH level during operation of the pasteurization plant 1. The pH value of the at least one partial flow 19 can be influenced by regulating a quantity of process liquid flowing through the ion exchanger(s) 32, 33 and/or through the entire ion exchange device 24 for example, as will be explained in more detail.

In principle, in order to influence the pH value of the at least one partial flow 19 in a specific way, a ratio of an ion exchange total capacity of all the available strongly acidic cation exchangers 32 to an ion exchange total capacity of all the available, strongly basic anion exchangers 33 is selected depending on requirements with a view to obtaining a desired pH value of the at least one partial flow 19 or the process liquid. A pH value of the at least one partial flow 19 is preferably adjusted to a slightly acidic level. For example, it may be of advantage if an average pH value of the process liquid for treating the external surface of the containers is between 4 and 7 during operation of the pasteurization plant 1. This may be of advantage as a means of preventing the occurrence of so-called wet storage stain on aluminum materials on the treated containers, for example. Accordingly, the ion exchange total capacity of all the available strongly acidic cation exchangers 32 may be selected so that it is higher than the ion exchange total capacity of all the available strongly basic anion exchangers 33. Care must naturally be taken to ensure that the ion exchange total capacity is sufficient to efficiently remove undesired dissolved ions from the at least one partial flow 19.

Based on one advantageous way of implementing the method, it may be of advantage if a content of dissolved ions in the partial flow 19 upstream and downstream of the ion exchange device 24 is monitored respectively by sensors. To this end, a sensor means for monitoring a content of ions dissolved in the partial flow 19 may be fluidically connected upstream and downstream of the ion exchange device 24 respectively. Such sensor means might be provided in the form of conductivity sensors or other suitable measuring devices which enable information to be gleaned about the content of ions, for example.

As illustrated by way of example in FIG. 2, a pH value sensor 34 may be fluidically connected upstream and downstream of the ion exchange device 24 respectively. As a result, a content of ions dissolved in the at least one partial flow 19 can be monitored by measuring a pH value of the at least one partial flow 19 upstream and downstream respectively of the point at which ions are removed by means of the ion exchange device 24 during operation of the pasteurization plant 1.

By providing the pH sensors 34, a sudden increase in the concentration of ions dissolved in the partial flow 19 or in the process liquid generally can be detected, for example. For example, a sudden increase in the concentration of metal cations in the process liquid can be detected because these metal cations are exchanged by means of the at least one strongly acidic cation exchanger 32 with solvated H⁺ ions. This can in turn be detected by means of the pH value sensors 34 directly due to a sudden drop in the pH value of the at least one partial flow 19 after it has passed through the at least one cation exchanger 32 of the ion exchange device 24. Steps can then be taken if necessary to prevent further soiling of the process liquid by undesired dissolved ions. At best, by providing the pH value sensors 34, it is even possible to detect errors in the implementation of the pasteurization process and/or unplanned and undesired influences on the method, for example due to containers that are leaking or soiled with metal or aluminum dust. At the same time, providing such pH sensors 34 is of advantage in that they serve as a reference or measuring means for influencing the pH value of the at least one partial flow 19 with a view to obtaining a desired pH level.

A pH value of the at least one diverted partial flow 19 can be influenced by means of the ion exchange device 24 by regulating a quantity of process liquid flowing through the ion exchange device 24, for example. To this end, the at least one cleaning device 16 is assigned a flow regulating device 35 as a control means 21 for regulating and/or adjusting a specific volumetric flow of the at least one partial flow 19 for example, as illustrated in both FIG. 1 and FIG. 2. A flow regulating device 35 may be a flow regulating element 36 such as a flow regulating valve or an adjustable flap or other appropriate adjustable regulating elements. A flow regulating device 35 may also comprise a flow sensor means 37 for measuring a respective quantity of process liquid or a volumetric flow of the at least one diverted partial flow 19 flowing through the cleaning device 16. During operation of the pasteurization plant 1, the partial quantity of process liquid 4 diverted from the at least one recirculation loop 11 in order to create the at least one partial flow 19 can therefore be regulated by means of a flow regulating device 35. This in turn enables a pH value of the at least one partial flow 19 to be influenced because depending on the flow quantity and/or depending on a volumetric flow of the at least one partial flow 19, more or fewer dissolved ions are exchanged by means of the strongly acidic cation exchanger(s) 32 and if necessary the strongly basic anion exchanger(s) 33. As schematically indicated in FIG. 2, an additional conveying means 12, preferably a speed-regulated pump for example, may be used to regulate a quantity of process liquid flowing through the cleaning device 16.

In principle, an ion exchange device 24 may be connected to the at least one cleaning device 16 in such a way that the entire at least one partial flow 19 of process liquid 4 diverted or removed from a recirculation loop 11 can be circulated through the ion exchange device 24, as schematically illustrated in FIG. 1. However, it is also of practical advantage if the ion exchange device 24 is fluidically connected to the at least one cleaning device 16 via at least one flow regulating means 38 parallel with a flow line 39 for the partial flow 19, as is the case with the embodiment illustrated as an example in FIG. 2. As a result, during operation of the pasteurization plant 1, at least a part of the process liquid removed from the partial flow 19 can be directed by means of at least one flow regulating means 38, for example a flow regulating element 36, via the ion exchange device 24 and then returned to the partial flow 19 again. As a result, a quantity of process liquid flowing through the ion exchange device 24 can basically be regulated independently of other elements of the at least one cleaning device 16 and thus the quantity of dissolved ions exchanged per unit of time influenced. In particular, the pH value of the at least one partial flow 19 can also be influenced independently of other elements of the at least one cleaning device 16. As illustrated in FIG. 2, an additional conveying means 12, preferably a speed-regulated pump for example, may also be used to regulate a quantity of process liquid flowing through the ion exchange device 24.

Alternatively or in addition, it may also be of advantage if a flow regulating means 38 is provided for every ion exchanger 32, 33 of the ion exchange device 24. As a result, during operation of the pasteurization plant 1, a quantity of process liquid flowing through the ion exchanger(s) 32, 33 can be regulated separately by means of a flow regulating means 38 respectively provided for each ion exchanger 32, 33 of the ion exchange device 24, as may be seen in FIG. 2. In this manner, the removal of dissolved ions from the at least one partial flow 19 can be controlled and regulated even more accurately and the pH value of the at least one partial flow 19 can be influenced and adjusted even more precisely.

As also illustrated in FIG. 2, the ion exchange device 24 may be fluidically connected to at least one regeneration means 40, 41 for regenerating the ion exchanger(s) 32, 33. Naturally, a regeneration means 40 with regenerating liquid for the cation exchanger(s) 32 and a regeneration means 41 with regenerating liquid for the anion exchanger(s) 33 may be provided. During operation of the pasteurization plant 1, the ion exchangers 32, 33 can then be respectively regenerated depending on requirements. In particular, the at least one strongly acidic cation exchanger 32 may be regenerated depending on a change in pH value of the partial flow 19. Similarly, the at least one strongly basic anion exchanger 33 may be regenerated depending on a change in pH value of the partial flow 19. To this end, as described above, pH sensors 34 may be provided respectively upstream and downstream of the ion exchange device 24. Spent regenerating liquid can in turn be fed out via a discharge 31.

To further improve cleaning efficiency for the process liquid, the at least one cleaning device 16 may comprise another liquid treatment device 42 having metal particles or a metal mesh incorporating copper and/or zinc. This liquid treatment device 42 may be fluidically connected between the membrane filtration device 23 and ion exchange device 24 in the at least one cleaning device 16. The liquid treatment device 42 may also be disposed parallel with a flow line 39 for the partial flow 19 in the at least one cleaning device 16 so that it can be selectively fluidically shut off or opened, as illustrated in FIG. 2. During operation of the pasteurization plant 1, the at least one partial flow can then be additionally circulated through a liquid treatment device comprising metal particles or a metal mesh incorporating copper and/or zinc before the dissolved ions are removed.

By means of such a liquid treatment device 42, spontaneous oxidation and/or reduction reactions with some of the substances dissolved in the process liquid can be initiated during operation of the pasteurization plant 1. As a result, more noble metal cations than zinc and/or copper, for example heavy metal ions, iron ions, etc., can be removed from a diverted partial flow 19 for example. This is also of advantage for improving the efficiency of the downstream ion exchange device 24 because the ions removed by means of the liquid treatment device 42 no longer have to be removed from the at least one partial flow 19 by means of the ion exchange device 24 and therefore are not competing with other ions dissolved in the partial flow 19 during the ion exchange. The usable ion exchange capacity of the ion exchangers 32, 33 of the ion exchange device 24 is therefore advantageously available for drawing off or removing other undesired dissolved ions that cannot be removed by means of the liquid treatment device 42, for example aluminum ions and/or ions of aluminum compounds.

Furthermore, the at least one cleaning device 16 may comprise an adsorption device 43, which adsorption device 43 is fluidically connected downstream of the ion exchange device 24. The adsorption device 43 may have an activated carbon filter 44, for example. As a result, during operation of the pasteurization plant 1, after dissolved ions have been removed by means of the ion exchange device 24, dissolved substances may additionally be removed from the at least one partial flow 19 by means of an adsorption device 43, for example by means of an activated carbon filter 44.

In principle, it may be of practical advantage if the at least one cleaning device 16 is disposed in a recirculation loop 11 and/or is connected to a recirculation loop 11 by pipes, in which recirculation loop 11 process liquid 4 is circulated at a slightly lower temperature during operation of the pasteurization plant 1, as also illustrated in FIG. 1. As a result of this in particular, operation of the individual devices 23, 26, 42, 43 of the at least one cleaning device 16 is as gentle as possible. The process liquid 4 can nevertheless be efficiently cleaned on a continuous basis because the individual volumetric elements of the process liquid 4 are constantly mixed in the pasteurization plant 1 due to the circulation and/or forced circulation of the process liquid via the recirculation loop 11 or recirculation loops 11. In other words, in such situations, individual volumetric elements of the process liquid 4 are circulated via changing recirculation loops 11 and into and out of changing treatment zones 2 over time during ongoing operation. This also makes it possible to influence a pH value of the entire process liquid by exchanging the dissolved ions of the at least one partial flow 19 by means of the ion exchange device 24 of the at least one cleaning device 16.

FIG. 3, finally, illustrates parts of another example of an embodiment of a pasteurization plant 1 which may be of advantage in terms of continuously reusing and cleaning the process liquid 4. In FIG. 3, the same reference numbers and component names are used for parts that are the same as those described with reference to FIGS. 1 and 2 above. To avoid unnecessary repetition, reference may be made to the more detailed description of FIG. 1 and FIG. 2 above.

As may be seen from the parts of the embodiment of the pasteurization plant 1 illustrated as an example in FIG. 3, the pasteurization plant 1 comprises an air-cooled cooling tower 45 having a heat exchanger 46 through which the process liquid 4 can be circulated if necessary. In this manner, a partial volumetric flow of process liquid 4 can be circulated via a heat exchanger 46 of an air-cooled cooling tower 45 depending on requirements.

Air-cooled cooling towers are often needed in pasteurization plants for cooling a part of the process liquid 4, which cooled process liquid 4 can in turn be used to cool containers on completion of the pasteurization process, for example. Due to the fact that cooling towers usually need a high cooling capacity, a considerable amount of contaminants occur in conventional cooling towers without a heat exchanger. By providing the heat exchanger 46, contaminants can be efficiently prevented from getting into the process liquid 4 via or in the air-cooled cooling tower 45.

As illustrated in FIG. 3, in order to cool a partial quantity of process liquid 4 for example, a partial quantity of process liquid 4 is transferred from a recirculation loop 11 by means of conveying means 12 into a process liquid tank 47, for example a collection tank or similar, depending on requirements. Also depending on requirements, process liquid 4 can then be pumped out of the process liquid tank 47 though the heat exchanger 46 of the cooling tower 45 by means of another conveying means 12 and thus cooled by cooling air and then be returned to the process liquid tank 47 again. The cooled process liquid 4 from the process liquid tank 47 can then be returned to the recirculation loop 11 illustrated by way of example in FIG. 3.

The embodiments illustrated as examples represent possible variants, and it should be pointed out at this stage that the invention is not specifically limited to the variants specifically illustrated, and instead the individual variants may be used in different combinations with one another and these possible variations lie within the reach of the person skilled in this technical field given the disclosed technical teaching.

The protective scope is defined by the claims. The description and drawings may be used to interpret the claims. Individual features or combinations of features from the different embodiments illustrated and described may be construed as independent inventive solutions or solutions proposed by the invention in their own right. The objective underlying the independent inventive solutions may be found in the description.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

For the sake of good order, finally, it should be pointed out that, in order to provide a clearer understanding of structure, constituent parts are illustrated to a certain extent out of scale and/or on an enlarged scale and/or on a reduced scale.

List of reference numbers

| | |
|---|---|
| 1 | Pasteurization plant |
| 2 | Treatment zone |
| 3 | Delivery means |
| 4 | Process liquid |
| 5 | External surface |
| 6 | Container |
| 7 | Conveyor device |
| 8 | Conveyor belt |
| 9 | Conveying direction |
| 10 | Floor region |
| 11 | Recirculation loop |
| 12 | Conveying means |
| 13 | Means |
| 14 | Means |
| 15 | Heating device |
| 16 | Cleaning device |
| 17 | Removal means |
| 18 | Returning means |
| 19 | Partial flow |
| 20 | T-piece |
| 21 | Control means |
| 22 | Shut-off means |
| 23 | Membrane filtration device |
| 24 | Ion exchange device |
| 25 | Conveying means |
| 26 | Filter module |
| 27 | Retentate chamber |
| 28 | Sealing means |
| 29 | Permeate chamber |
| 30 | Back-flush liquid source |
| 31 | Discharge |
| 32 | Cation exchanger |
| 33 | Anion exchanger |
| 34 | pH value sensor |
| 35 | Flow regulating device |
| 36 | Flow regulating element |
| 37 | Flow sensor means |
| 38 | Flow regulating means |
| 39 | Flow line |
| 40 | Regeneration means |
| 41 | Regeneration means |
| 42 | Liquid treatment device |
| 43 | Adsorption device |
| 44 | Activated carbon filter |
| 45 | Cooling tower |
| 46 | Heat exchanger |
| 47 | Process liquid tank |

1. Method of operating a pasteurization plant (1), comprising
conveying containers filled with food products and closed (6) through one or more treatment zone(s) (2),
treating the containers (6) with a tempered aqueous process liquid (4) in the treatment zone(s) (2) by applying the process liquid (4) to an external surface (5) of the containers (6),
wherein at least a part of the process liquid (4) from the treatment zone(s) (2) is fed back to a treatment zone (2) for reuse in at least one recirculation loop (11),
and wherein
at least a partial quantity of a volumetric flow of the process liquid (4) fed per unit of time via the at least one recirculation loop (11) is diverted to create at least one partial flow (19),
which at least one partial flow (19) is filtered by means of a membrane filtration device (23),
and dissolved ions are then removed from the at least one partial flow (19) by means of an ion exchange device (24) having at least one strongly acidic cation exchanger (32),
and the at least one partial flow (19) is then returned to a recirculation loop (11) or a treatment zone (2) again.

2. Method according to claim 1, wherein a pH value of the partial flow (19) is influenced means of the at least one strongly acidic cation exchanger (32) with a view to obtaining a desired pH level.

3. Method according to claim 1, wherein the at least one strongly acidic cation exchanger (32) is regenerated depending on a change in pH value of the partial flow (19).

4. Method according to claim 1, wherein anions are removed from the partial flow (19) by means of at least one strongly basic anion exchanger (33).

5. Method according to claim 4, wherein a pH value of the partial flow (19) is influenced by means of the at least one strongly basic anion exchanger (33) with a view to obtaining a desired pH level.

6. Method according to claim 4, wherein the at least one strongly basic anion exchanger (33) is regenerated depending on a change in pH value of the partial flow (19).

7. Method according to claim 1, wherein a content of ions dissolved in the partial flow (19) is monitored by sensors upstream and downstream of the ion exchange device (24) respectively.

8. Method according to claim 7, wherein a content of ions dissolved in the partial flow (19) is monitored by measuring a pH value of the partial flow (19) respectively upstream and downstream of the point where ions are removed by means of the ion exchange device (24).

9. Method according to claim 1, wherein the partial quantity of process liquid (4) diverted from the at least one recirculation loop (11) in order to create the partial flow (19) is regulated by means of a flow regulating device (35).

10. Method according to claim 1, wherein at least a part of the process liquid (4) removed from the partial flow (19) by means of at least one flow regulating means (38) is fed through the ion exchange device (24) and then returned to the partial flow (19) again.

11. Method according to claim 10, wherein a flow quantity of process liquid (4) through the ion exchanger(s) (32, 33) is regulated respectively by means of a flow regulating means (38) separately for each ion exchanger (32, 33) of the ion exchange device (24).

12. Method according to claim 1, wherein before removing the dissolved ions, the partial flow (19) is additionally directed through a liquid treatment device (42) comprising metal particles or a metal mesh comprising copper and/or zinc.

13. Method according to claim 1, wherein after removing dissolved ions, dissolved substances are also removed from the partial flow (19) by means of an adsorption device (43).

14. Method according to claim 13, wherein the dissolved substances are removed from the partial flow (19) by means of an activated carbon filter (44).

15. Method according to claim 1, wherein the food products in the containers (6) are heated in a treatment zone (2) or are heated in several treatment zones (2) successively and then pasteurized in a treatment zone (2) or several treatment zones (2),, after which they are cooled in a treatment zone (2) or cooled in several treatment zones (2) successively.

16. Method according to claim 1, wherein a partial volumetric flow of process liquid (4) is directed through a heat exchanger (46) of an air-cooled cooling tower (45), depending on requirements.

17. Method according to claim 1, wherein containers (6) incorporating a metal material, in particular an aluminum material, can be treated by means of the pasteurization plant (1), at least temporarily.

18. Pasteurization plant (1), comprising one or more treatment zone(s) (2) with delivery means(n) (3) for applying a tempered process liquid (4) to an external surface (5) of containers (6),
a conveyor device (7) for conveying the containers (6) through the treatment zone(s) (2),
and at least one recirculation loop (11) for diverting the process liquid (4) from the treatment zone(s) (2) and for recirculating at least a part of the diverted process liquid (4) to a treatment zone (2),
wherein
at least one cleaning device (16) is provided, which at least one cleaning device (16) is fluidically connected to a removal means (17) for removing a partial flow (19) of process liquid (4) from the at least one recirculation loop (11), and which at least one cleaning device (16) is connected to a returning means (18) for returning the partial flow (19) to a recirculation loop (11) or a treatment zone (2),
which at least one cleaning device (16) comprises a membrane filtration device (23) for filtering the partial flow (19),
and which at least one cleaning device (16) comprises an ion exchange device (24) having at least one strongly acidic cation exchanger (32) fluidically connected downstream of the membrane filtration device (23).

19. Pasteurization plant according to claim 18, wherein the ion exchange device (24) comprises at least one strongly basic anion exchanger (33).

20. Pasteurization plant according to claim 18, wherein the ion exchange device (24) is fluidically connected to at least one regeneration means (40, 41) for regenerating the ion exchanger(s) (32, 33).

21. Pasteurization plant according to claim 18, wherein a sensor means for monitoring a content of ions dissolved in the partial flow (19) is arranged fluidically upstream and downstream of the ion exchange device (24) respectively.

22. Pasteurization plant according to claim 21, wherein a pH value sensor (34) is arranged fluidically upstream and downstream of the ion exchange device (24) respectively.

23. Pasteurization plant according to claim 19, wherein a ratio of an ion exchange total capacity of all the available strongly acidic cation exchangers (32) to an ion exchange total capacity of all the available strongly basic anion exchangers (33) is selected depending on requirements with a view to obtaining a desired pH value of the partial flow (19) or process liquid (4).

24. Pasteurization plant according to claim 18, wherein a flow regulating device (35) is assigned to the at least one cleaning device (16).

25. Pasteurization plant according to claim 18, wherein the ion exchange device (24) is arranged fluidically parallel with a flow line (39) for the partial flow (19) in the at least one cleaning device (16) via at least one flow regulating means (38).

26. Pasteurization plant according to claim 25, wherein every ion exchanger (32, 33) of the ion exchange device (24) is assigned a flow regulating means (38).

27. Pasteurization plant according to claim 18, wherein the at least one cleaning device (16) comprises another liquid treatment device (42) comprising metal particles or a metal mesh comprising copper and/or zinc, which liquid treatment device (42) is fluidically connected between the membrane filtration device (23) and the ion exchange device (24).

28. Pasteurization plant according to claim 18, wherein the at least one cleaning device (16) comprises an adsorption device (43), which adsorption device (43) is fluidically connected downstream of the ion exchange device (24).

29. Pasteurization plant according to claim 28, wherein the adsorption device (43) has an activated carbon filter (44).

30. Pasteurization plant according to claim 18, wherein it comprises an air-cooled cooling tower (45) having a heat exchanger (46) through which the process liquid (4) can be guided if necessary.
